(19) United States
(12) Patent Application Publication
(10) Pub. No.: US 2004/0027366 A1
(43) Pub. Date: Feb. 12, 2004

(54) Response system

(76) Inventors: Sunao Takatori, Tokyo (JP); Hisanori Kiyomatsu, Chiba (JP)

Correspondence Address: Kanesaka & Takeuchi, 1423 Powhatan Street, Suite 2, Alexandria, VA, 22314, US

(21) Appl. No.: 10/399,447

(22) PCT Filed: Mar. 30, 2001
(86) PCT No.: PCT/JP01/02753

(30) Foreign Application Priority Data
Oct. 17, 2000 (JP) 2000-316059

(51) Int. Cl. G09B 19/00; G09G 5/00

(52) U.S. Cl. 345/708; 434/118

(57) ABSTRACT

A response system (for example, user support system) in which a response service system (for example, a user support service system) is facilitated by incorporating a telecommuting responder so as to solve the conventional problem that it has been difficult to secure a responder on the premises. A communication control device (1), upon receiving a call of a request for support about a specific product from a videophone (12) on the user side, calls at a time a videophone (26) of a responder on the premises capable of supporting the user about the specific product and a videophone (22) of a telecommuting responder also capable of supporting the user about the product and connects the one who first responds to the videophone (12) on the user side. As a result, a user support system capable of incorporating a telecommuting responder who may be out of his or her home can be built.

### TECHNICAL FIELD

The present invention relates to a response system such as a user support system for facilitating establishment of a system for a so-called user support service with which, for example, when a manufacturer receives an inquiry from a customer, that is, a user, with a communication apparatus such as a telephone about a question in utilizing various electronic devices, various kinds of software, or the like, the manufacturer side responds to the question (besides the user support system, a response system for a telephone shopping, a response system for medical consultants, a response system for travel consultants, and the like are included).

### BACKGROUND ART

For instance, if an explanation is made with a user support system as an example, in recent years, it has generally become difficult for a user to manage electronic devices (e.g., a personal computer and a cellular phone), various kinds of software (e.g., word processor software and accounting software) and the like simply by reading a user guide (so-called manual) attached to them because their structures and configurations have become complicated as they realize high functionality. In order to cope with such a situation, a large number of manufacturers have established systems for a user support service for, when users utilizing products of the manufacturers make inquiries by a telephone concerning various questions in utilizing the products, appropriately responding to the inquiries.

In the service system as described above, considering that contents of inquiries from users will be diversified, it is common that a manufacturer assigns special responders for each product of the manufacturer or each field of the manufacturer's products in advance, respectively, and has those large number of responders to always stand by in rooms of a user support section or the like (even in the case in which the rooms of the section are dispersed to some extent, at least in the same site in which a call can be transferred by extensions) during working hours. Then, when a user calls a telephone number (which is publicly announced) dedicated for user support, the user is asked to. specify an object of inquiry (e.g., product) and, according to the specified object of inquiry, the call from the user is connected to an in-house telephone for a responder for the object of inquiry via a PBX (private branch exchange system) or the like, and the responder responds the inquiry call from the user.

The responders as described above are required to have not only wide-ranging and professional knowledge concerning products or the like which the responders are in charge of and peripheral technologies related thereto but also communication ability for accurately grasping a matter of inquiry from a user and explaining the matter of inquiry plainly.

However, it is impossible to train the responders with sufficient ability as those described above in a short time and, therefore, in general, it has become relatively difficult for a manufacturer to employ a sufficient number of such responders and have them work full-time in the user support section or the like in the manufacturer as described above. Further, this makes the establishment itself of the above-described user support service system difficult, and it is likely that this tendency will become more and more conspicuous from now on.

On the other hand, there are a relatively large number of people who have previously worked for manufacturers and experienced work of a responder as one described above for a long time but stay at home due to so-called marriage retirement, compulsory retirement, or the like, and wishes to work once more as a responder if they may work at home, although there is a hindrance to go to office and work (e.g., due to child care).

Such a situation is not peculiar to the user support service system.

The present invention has been devised in view of the above-described circumstances, and it is an object of the present invention to provide a response system (besides a user support system, a response system for telephone shopping, a response system for medical consultants, a response system for travel consultants, and the like are included) which can involve responders at home or the like and, thereby facilitating establishment of a response service system.

### DISCLOSURE OF THE INVENTION

In the first invention, a communication control apparatus is constituted as described below which is used in a response system (e.g., the above-described user support system, response system for telephone shopping, etc.) with which, when an inquiry is sent from a caller who is a customer, that is, a user or the like, to a receiver side which is a manufacturer or the like with a communication apparatus (which refers to, in this specification, for example, a telephone, a videophone, an Internet telephone, a personal computer for network communication, or the like), the receiver side responds to the inquiry.

That is, the communication control apparatus is constituted to include:

connection destination instructing means which executes processing for calling communication apparatuses which several registered responders including at least one person who is a worker on the above-described receiver side other than in-house workers (e.g., a telecommuting worker, a worker in an overseas department, or a worker in a related company or organization) use, respectively, using call information for calling the respective communication apparatuses and via an in-house leased line with respect to the communication apparatuses of the in-house workers or via a public communication line with respect to the communication apparatuses of workers other than the in-house workers, and instructs to connect a communication apparatus which has responded to the call first to the communication apparatus on the above-described caller side; and

a connection device which connects the above-described communication apparatus which has responded to the call first and the communication apparatus on the above-described caller side based upon the instruction of the above-described connection destination instructing means.

In a second invention, a communication control apparatus is constituted as described below which is used in a response system with which, when an inquiry is sent from a caller who is a customer, that is, a user or the like, to a receiver side which is a manufacturer or the like with a communication apparatus, the receiver side responds to the inquiry.

That is, the communication control apparatus is constituted to include:

object specification requesting means which, upon receiving a call from a communication apparatus on a caller side via a communication line (which refers to, in this specification, for example, a general public line including a switchboard, a wireless line, the Internet, a line utilizing an electric wire for wired television, or the like), sends a signal for requesting to specify an object of inquiry (e.g., a specific product, commodity, or the like of the manufacturer or seller) or indicating a method of specifying an object of inquiry and requesting to specify the object of inquiry with the method of specification;

responder candidate designation means which, when an object specifying signal specifying an object of inquiry is sent from the communication apparatus of the above-described caller side in response to the above-described signal from the above-described object specification requesting means, reads out each piece of call information (e.g., telephone number when the communication apparatus is a telephone) for calling each communication apparatus which several responders who are expected to respond about the object of inquiry use, respectively, from responder classification storing means described below in accordance with an order of a responding ability described below based upon the object specifying signal;

responder classification storing means in which each piece of call information for calling each communication apparatus which several responders including at least one person who is a worker other than the in-house workers on the above-described receiver side use, respectively, and an object of inquiry to which a responder relating to the call information is expected to respond are associated with each other and stored in a form with which an order of responding ability of the responders relating to those pieces of call information can be understood among the pieces of call information relating to the responders responding to an identical object of inquiry;

connection destination instructing means which continues processing for calling each communication apparatus relating to each piece of call information one by one in the above-described order of a responding ability based upon the above-described each piece of call information read out by the above-described responder designation means until any one of the communication apparatuses responds to call, and instructs to connect the communication apparatus having responded to the call first and the communication apparatus on the above-described caller side; and

a connection device which connects the above-described communication apparatus having responded to the call first and the communication apparatus on the above-described caller side based upon the instruction of the above-described connection destination instructing means.

In a third invention, a communication control apparatus is constituted as described below which is used in a response system with which, when an inquiry is sent from a caller who is a customer, that is, a user or the like, to a receiver side which is a manufacturer or the like with a communication apparatus, the receiver side responds to the inquiry.

That is, the communication control apparatus is constituted to include:

object specification requesting means which, upon receiving a call from a communication apparatus on a caller side via a communication line, sends a signal for requesting specification of an object of inquiry or indicating of a method of specifying an object of inquiry and requesting specification of the object of inquiry with the method of specification;

responder candidate designation means which, when an object specifying signal specifying an object of inquiry is sent from the communication apparatus of the above-described caller side in response to the above-described signal from the above-described object specification requesting means, reads out each piece of call information for calling each communication apparatus which several responders who are expected to respond about the object of inquiry use, respectively, from responder classification storing means described below based upon the object specifying signal;

responder classification storing means in which each piece of call information for calling each communication apparatus which several responders including at least one person who is a worker other than the in-house workers on the above-described receiver side use, respectively, and an object of inquiry to which a responder relating to the call information is expected to respond are associated with each other and stored;

connection destination instructing means which calls at a time all communication apparatus relating to these pieces of call information based upon the above-described each piece of call information read out by the above-described responder designation means, via an in-house leased line with respect to the communication apparatuses of the in-house workers or via a public communication line with respect to the communication apparatuses of workers other than the in-house workers, and instructs connection of a communication apparatus having responded to the call first and a communication apparatus on the above-described caller side; and

a connection device which connects the above-described communication apparatus having responded to the call first and the communication apparatus on the above-described caller side based upon the instruction of the above-described connection destination instructing means.

In a fourth invention, an image creating device described below is further added to each communication control apparatus in accordance with the above-described first to third inventions which is used in the case in which the communication apparatus on the above-described caller side is provided with a display section and has a function for receiving an image signal sent thereto and displaying a moving image on the display section.

That is, an image creating device is added which, while the above-described responder is responding to an inquiry, generates an image signal for displaying a moving image which looks as if a specific character (e.g., an image character of the manufacturer or a seller, etc.) performs the response, and transmits the image signal to the communication apparatus on the above-described caller side.

In a fifth invention, a speech conversion device described below is added to each communication control apparatus in accordance with the above-described first to fourth inventions.

That is, a speech conversion device is added which, while the above-described responder is responding to an inquiry, takes in voices of the response sent thereto, converts the voices into voices of a specific person (image character of the manufacturer or a seller, etc.) other than the responder and, then, transmits a voice signal relating to the voices after conversion to the communication apparatus on the above-described caller side instead of the voice signal of the responder.

In a sixth invention,

a speech recognition device which converts a conversation of questions and answers between the above-described caller and the above-describe responder into character data representing the conversation,

a storage device for database preparation, and

database preparation means which arranges and records the above-described character data in an association with other data relating to the caller on the storage device to prepare a database are added to each communication control apparatus in accordance with the above-described first to fifth inventions.

In the seventh invention, a response system is constituted as described below.

That is, the response system is constituted to include:

the communication apparatus on the above-described caller side;

the communication control apparatus in accordance with any one of the above-described first to sixth inventions; and

each communication apparatus of the above-described each responder to be selectively connected to the communication apparatus on the above-described caller side by the communication control apparatus.

In an eighth invention, a recording medium (e.g., CD-ROM, etc.) to be passed to a purchaser, that is, the above-described caller, at the purchasing time or the like of the above-described product or the like, in which data or the like specifying the product or the like is stored, is added to the response system in accordance with the seventh invention, and

The communication apparatus on the above-described caller side is also given a function for reading the recording medium and connecting the communication apparatus to the above-described communication control apparatus to transmit the above-described object specifying signal specifying the above-described product or the like to be an object of inquiry in response to a request from the communication control apparatus side or automatically at predetermined timing.

In a ninth invention, the recording medium of the response system in accordance with the eighth invention is an ID card (a magnetic card, an IC card, a bar code card, etc. having recorded an ID, etc. therein).

In addition, the communication control apparatus in accordance with the present invention includes a connection device which connects a communication apparatus owned by a customer and one of communication apparatuses owned by a plurality of responders, selects responders who respond to an inquiry from the customer, calls the communication apparatuses of the selected responders at a time using call information for calling the respective communication apparatuses, and enables a direct call between the customer and a responder who responded to the call first. Consequently, the communication apparatuses of the responders are not limited and various kinds of user support are possible.

In addition, the communication control apparatus in accordance with the present invention further includes an image creating device which creates an image of a responder, with which the responder may call a customer while displaying the generated image on a communication apparatus of the customer. Consequently, burden on the responder can be reduced and good impression can be given to the customer.

The communication control apparatus in accordance with the present invention further includes a speech conversion device which converts voices of a responder to generate image voices, with which the responder may call the customer with the image voices. Consequently, burden on the responder can be reduced and good impression can be given to the customer.

The communication control apparatus in accordance with the present invention further includes a speech recognition device which converts a conversation between a customer and a responder into character data and a database which records this character data in an association with the customer, and can arrange contents of support as a database. A telephone response system and a telephone response service using this communication control apparatus can arrange contents of support as a database easily and can utilize this as a marketing material.

The telephone response system in accordance with the present invention includes a communication control apparatus and a storage medium, for example, an ID card having information concerning an ID of a customer recorded therein, and a communication apparatus of the customer reads the storage medium to connect to the above-described communication control apparatus. Consequently, customer authentication can be performed easily and surely and, at the same time, a connection operation can be simplified.

The telephone response service in accordance with the present invention converts a conversation between a customer and a responder into character data to arrange it as database and utilizes this in marketing. Therefore, powerful marketing becomes possible and, at the same time, the database can be reflected on planning of products.

In the telephone response system and the telephone response service in accordance with the present invention, a responder may be a telecommuting responder. Consequently, a range of responders can be enlarged, and a user support service system can be realized easily.

### BRIEF DESCRIPTION OF THE DRAWINGS

FIG. 1 is a view showing a structure of an embodiment of the present invention. In addition,

FIG. 2 is a flowchart showing an outline of an operation of a main control section 200,

FIG. 3 is a flowchart showing an outline of an operation of a sub-control section, and

FIG. 4 is a flowchart showing an outline of responder selection processing in FIG. 3. Further,

FIG. 5 is a flowchart showing an outline of another example of the responder selection processing. In addition,

FIG. 6 is a block diagram showing a second embodiment of the communication control apparatus, the telephone response system, and the telephone response service in accordance with the present invention. Further,

FIG. 7 is a block diagram showing a third embodiment.

FIG. 8 is a table showing data to be stored in a database of the third embodiment.

FIG. 9 is a conceptual view showing a user registration format of the third embodiment.

FIG. 10 is a flowchart showing processing of a fourth embodiment.

FIG. 11 is a block diagram showing a fifth embodiment. In addition,

FIG. 12 is a block diagram showing details of the fifth embodiment.

FIG. 13 is a perspective view showing a communication apparatus of a customer in a sixth embodiment, and

FIG. 14 is a flowchart showing processing of the sixth embodiment.

21 Public communication network

25 In-house leased network

3 Connecting devices

2 Control unit

200 Main control section

4 Speech conversion devices

5 Image creating devices

6 Speech recognition devices

7 Database

11 Public communication network

### BEST MODE FOR CARRYING OUT THE INVENTION

In order to describe the present invention more in detail, will be described in accordance with the accompanying drawings.

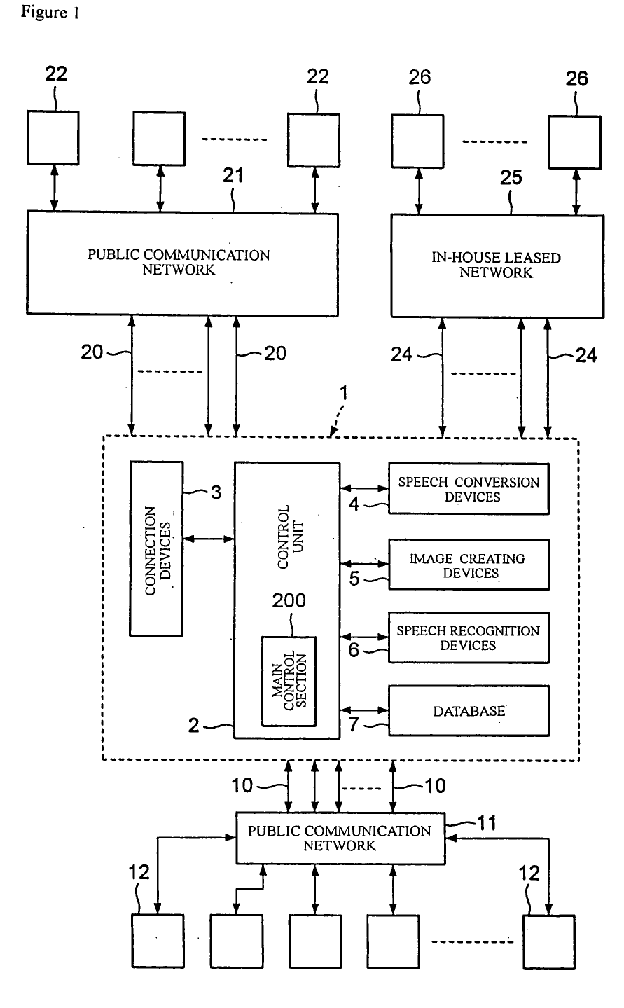

FIG. 1 shows a structure of a user support system in accordance with this embodiment. Note that, in the system, of a communication apparatus used by a user and a communication apparatus used by a responder are videophones, maximum nine users can simultaneously perform questions answers with one responder, respectively.

In FIG. 1, a communication control apparatus 1 is an apparatus which, upon receiving a call sent from a videophone 12 on a user side via a public communication network 11 and communication lines 10, performs a communication control operation such as selecting one out of videophones 22 used by responders working on the premises of the manufacturer and videophones 26 used by telecommuting responders in response to an inquiry of the user, and connecting the selected videophone to the videophone 12 on the above-described user side. Note that a large number sets of the above-described videophone 22 are provided, each of which is selected and connected to the communication control apparatus 1 via communication lines 20 for predetermined lines and a public communication network 21. In addition, a large number sets of the above-described videophones 26 are provided, each of which is connected to the communication control apparatus 1 via communication lines 24 for predetermined lines and an in-house leased network 25.

The above-described communication control apparatus 1 is provided with a control unit 2, connection devices 3, speech conversion devices 4, image creating devices 5, speech recognition devices 6, and a database 7 (abbreviated in this way although it is precisely a storage device for database establishment). The control unit 2 includes a main control section 200 and nine sub-control sections, that is, a first sub-control section 201 to a ninth sub-control section 209, and these main control section 200 and nine sub-control section have a CPU, an ROM, and an RAM independently from each other. The connection devices 3 have nine connection devices, that is, a first connection device 301 to a ninth connection device 309, which connect any one of the communication lines 10 and any one of the communication lines 20 or the communication lines 24, respectively. Note that control of the nine connection devices is performed by the above-described nine sub-control sections, respectively, in such a way as control of the first connection device 301 is performed by the first sub-control section 201 and control of the second connection device 302 is performed by the second sub-control section 202.

The speech conversion devices 4 have nine speech conversion devices, that is, a first speech conversion device 401 to a ninth speech conversion device 409. These are devices which take in voices of each responder, converts the voices into voices of an image character of the above-described manufacturer and, then, transmits a voice signal relating to the voices of this image character to the communication apparatus on the above-described user side instead of a voice signal of the responder, respectively. Note that control of the nine devices is performed by the above-described nine sub-control sections, respectively, in such a way as control of the first speech conversion device 401 is performed by the first sub-control section 201 and control of the second speech conversion device 402 is performed by the second sub-control section 202.

The image creating devices 5 have nine image creating devices, that is, a first image creating device 501 to a ninth image creating device 509. These are devices which takes in an image of each responder, creates an image signal of a moving image, which looks as if an image character of the above-described manufacturer is responding, based upon the image, and transmits the image signal to the above-described user side communication apparatus, respectively. Note that control of the nine devices is performed by the above-described nine sub-control sections, respectively, in such a way as control of the first image creating device 501 is performed by the first sub-control section 201 and control of the second image creating device 502 is performed by the second sub-control section 202.

The speech recognition devices 6 have nine speech recognition devices, that is, a first speech recognition device 601 to a ninth speech recognition device 609. These are devices which convert a conversation of questions and answers between a user and a responder into character data representing it, respectively. Note that control of the nine devices is performed by the above-described nine sub-control sections, respectively, in such a way as control of the first image creating device 501 is performed by the first sub-control section 201 and control of the second image creating device 502 is performed by the second sub-control section 202.

In addition, data for a database based upon the character data converted by the above-described nine speech recognition devices and other data is accumulated in the database 7 by the above-described first sub-control section 201 to ninth sub-control section 209.

As described above, the communication control apparatus 1 is provided with nine system sections consisting of the nine sub-control sections and the three types of devices (i.e., the speech conversion devices, the image creating devices, and the speech recognition devices) to be controlled by one of the sub-control sections, respectively, other than the main control unit 200 and the database 7 (in the description below, a system section consisting of the first sub-control section 201, the first connection device 301, the first speech conversion device 401, the first image creating device 501, and the first speech recognition device 601 is referred to as a first system, a system section consisting of the ninth sub-control section 209, the ninth connection device 309, the ninth speech conversion device 409, the ninth image creating device 509, and the ninth speech recognition device 609 is referred to as a ninth system, and the like.) Further, since each system backs up a set of questions and answers (questions and answers between one user and one responder), respectively, in the user support system using the communication control device 1, nine sets of questions and answers can be executed in parallel simultaneously.

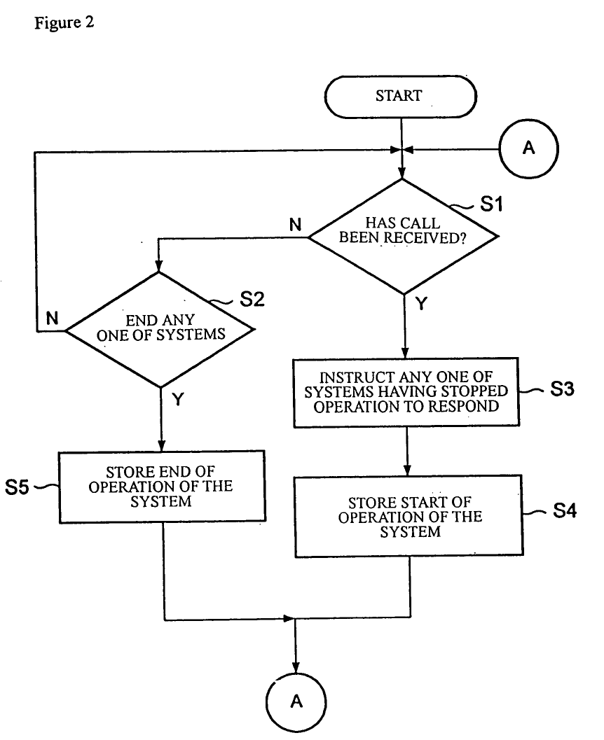

Next, operations of the above-described embodiment constituted as described above will be described. FIG. 2 shows operations according to the above-described main control section 200. That is, this main control section 200, upon starting the operations, stands by for a call utilizing any one of the videophone 12 sent by a user and a signal to the effect that processing performed by any one of the systems has ended from the system (steps S1, S2, and S1). Then, when the call utilizing any one of the videophones 12 is sent by the user, the main control section 200 detects it in step S1 and proceeds to step S3. In step S3, the main control section 200 searches for a system which has stopped operation among the above-described nine systems and instructs the sub-control section of the system to respond to the above-described call (e.g., now, it is assumed that the main control section 200 has instructed the ninth sub-control section 209 to do so). Thereafter, in step S4, the main control section 200 stores in a specific memory in the RAM of the main control section 200 to the effect that the system, that is, the ninth system, has started operation and is currently operating, and then returns to step Si, and comes into the above-described standby state (steps S1, S2, and S1). When a signal indicating an end of the operations, that is, an end of the inquiry utilizing the system and the response (user support), is sent from the sub-control section of any one of the systems, that is, the system during this standby state, the main control section 200 detects it in step S2 and proceeds to step S5. In step S5, the main control section 200 stores in the above-described specific memory in the RAM of the main control section 200 to the effect that the operations of the system has ended and, thereafter, returns to step S1 and comes into the above-described standby state.

Next, operations performed by the sub-control section of each system will be described. Since the operations performed by the sub-control section of each system are the same in any system, operations performed by the ninth sub-control section 209 of the ninth system will be illustratively described.

The ninth sub-control section 209 starts upon receiving a response instruction of the main control section 200 (see step S3 of FIG. 2) and, first, in step S10, obtains a telephone number of the videophone 12 on a user side called this time by the “caller number notice service” and stores it in a specific memory of the RAM in the ninth sub-control section 209 (this is used for preparing a database in processing described later) In the subsequent step S11, in order to have the user specify about which product of the manufacturer the user wishes to inquire, the ninth sub-control section 209 indicates a specific method for an object of inquiry and sends a signal requesting specification of the object of inquiry with the specification method (e.g., a voice signal such as “please operate a dial key of 1 if you use a personal computer, a dial key of 2 if you use a modem, a dial key of 3 if you use a printer, a dial key of 4 if you use an externally attached hard disk, or a dial key of 5 if you use other products”).

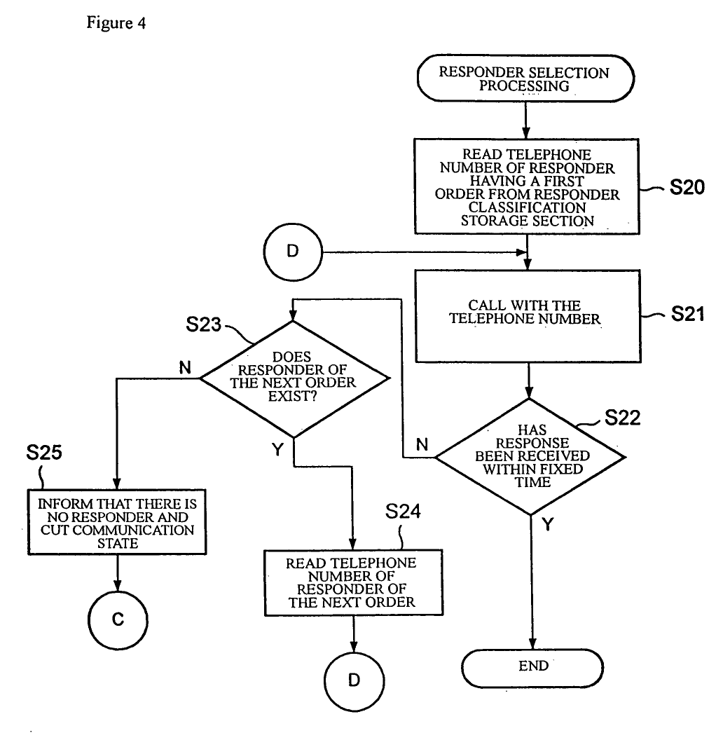

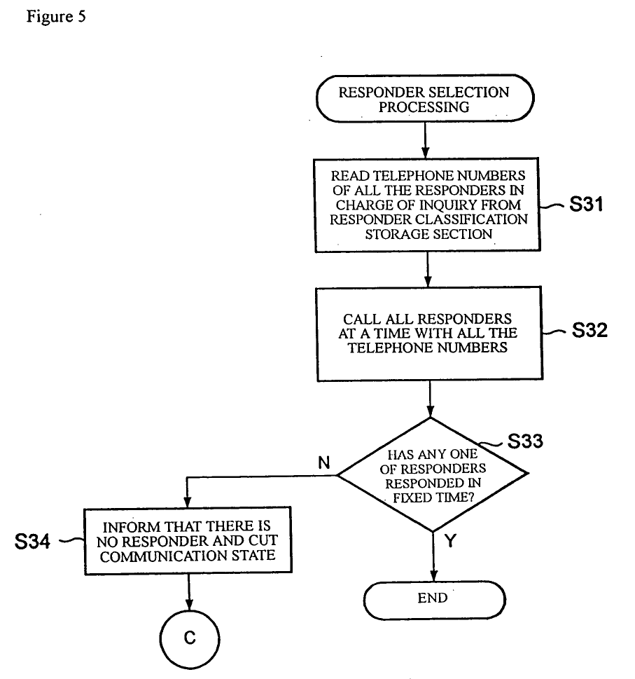

Thereafter, the ninth sub-control section 209 proceeds to step S12, stands by for an object specifying signal (e.g., a signal according to an operation of the dial key of 2 indicating a modem), which is in response to a response from the user side, that is, the above-described signal, only for a fixed time and, when the object specifying signal has been sent to it, proceeds to the next step S13. In step S13, the ninth sub-control section 209 selects a responder (including responders on the premises, other telecommuting responders, etc.) who is in charge of the object of inquiry utilizing the responder classification storage section in the RAM in the ninth sub-control section 209 (this processing will be described in detail later using FIGS. 4 and 5). Subsequently, in step S14, the ninth sub-control section 209 instructs the ninth connection device 309 in the ninth system to connect the videophone 26 of the responder selected in the processing of step S13 (in this case, it is assumed that a responder other than the responders on the premises is selected) and the videophone 12 of the above user. Consequently, the ninth connection device 309 executes the connection operation and questions and answers between both the parties become possible.

After executing the processing of step S14, in step S15, the ninth sub-control section 209 sends an instruction of starting operation to the ninth speech conversion device 409, the ninth image creating device 509, and the ninth speech recognition device 609 of the identical system, that is, the ninth system. Consequently, the ninth speech conversion device 409 stars operations for taking in voices of a response to be sent from the above-described responder side and converting this into voices of an image character of the manufacturer to send it to the above-described user side, the ninth image creating device 509 starts operations for creating an image signal for displaying an image, which looks as if the image character of the manufacturer is responding, and sending it to the above-described user side, and the ninth speech recognition device 609 starts operations for recognizing the voices of questions and answers between the above-described both parties, converting the voices into character data representing it, and storing it in the storage section in the ninth speech recognition device 609.

The ninth sub-control section 209 stands by in step S16 while the questions and answers between the above-described both parties continue and the operations of the above-described each device following the questions and answers continue and, when the questions and answers end, detects the end in step S16 according to a signal of call end to be sent via the communication line 10 or the like and, then, proceeds to step S18. In this step S18, the ninth sub-control section 209 arranges the above-described character data stored in the storage section in the above-described ninth speech recognition device 609 and the above-described telephone numbers or the like stored in the specific memory of the RAM in the ninth sub-control section 209 and enriches the database 7 by adding these data thereto. Note that the database formed by adding and storing the data can be utilized as an extremely valuable basic material in marketing.

After the processing of step S18 ends or when the above-described object specifying signal has not been sent from the user side within the fixed time in step S12, the ninth sub-control section 209 sends an end signal to the effect that the operations of the ninth system is finished to the main control section 200 (this is detected by the main control section 200 in step S2 of FIG. 2) and ends the operations performed by the ninth sub-control section 209.

Next, responder selection processing of step S13 will be described in detail using FIG. 4. In the processing, first, in step S20, the ninth sub-control section 209 reads a telephone number of a responder having a highest responding ability with respect to the product of the object of inquiry out of a large number of pieces of call information, that is, telephone numbers stored in the responder classification storage section (provided in the RAM in the ninth sub-control section 209). Note that, in the storage section, for each product to be an object of inquiry, telephone numbers of the videophones 22 and 26 which a large number of responders (including telecommuting responders, etc.) use for the product, respectively, are stored in the order of responding ability of the responders.

Subsequently, in step S21, the ninth sub-control section 209 uses the above-described read out telephone number to call a videophone relating to the telephone number and stands by for a response to the call only for a fixed time. When a response has been received during the standby time, the ninth sub-control section 209 ends the responder selection processing and, when a response has not been received during the standby time, the ninth sub-control section 209 proceeds to step S23.

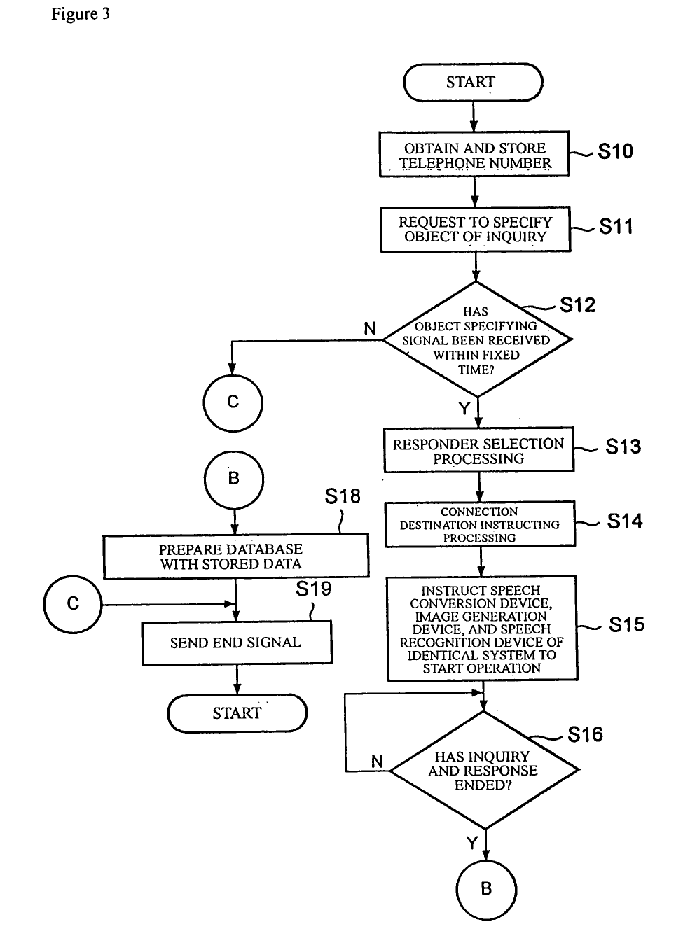

In step S23, the ninth sub-control section 209 checks if a telephone number of a responder who is ranked next to the above-described responder in the responding ability order is stored in the above-described responder classification storage section and, when it is stored, proceeds to step S24, reads the telephone number, thereafter returning to step S21 to repeat the same processing as above (steps S21, S22, S23, S24, and S21). Note that, when the processing is repeated to call all the responders stored in the above-described responder classification storage section sequentially as a person to be in charge of the above-described inquiry but no response is received and there is no more responder to call next, the ninth sub-control section 209 detects to that effect in step S23 and proceeds to step S25, where the ninth sub-control section 209 sends a message notifying that there is no responder to the user side and, then, cuts the line with the user side and proceeds to step S19 of FIG. 3.

Note that the responder selection processing shown in FIG. 4 may be changed to processing as shown in FIG. 5. That is, in step S31, the ninth sub-control section 209 reads telephone numbers of all the responders for the product of the object of inquiry out of the large number of pieces of call information, that is, telephone numbers stored in the responder classification storage section. Note that, in the storage section, for each product to be an object of inquiry, telephone numbers of the videophones 22 and 26 which a large number of responders (including telecommuting responders, etc.) for the product, respectively, are stored in advance (in this case, the telephone numbers are not required to be stored in the order of the responding ability). Thereafter, in step S32, using the above-described telephone numbers read out from the storage section, the ninth sub-control section 209 calls all the videophones 22 and 26 relating to the above telephone numbers and, in the subsequent step S33, stands by for a response with respect to the call only for a fixed time. When a response is received from any one of the videophones within the standby time, the ninth sub-control section 209 selects only the videophone relating to the first response to finish the responder selection processing. However, when no response is received from any videophone within the standby time, the ninth sub-control section 209 proceeds to step S34, sends a message notifying that there is no responder to the user side and, then, cuts the line with the user side to proceed to step S19 in FIG. 3.

Both the selection methods adopted by the above-described two responder selection processing are so useful that it can be said that it is essential in establishing a user support service involving telecommuting workers or the like as responders. This is because in the case of the telecommuting workers or the like, they do not always standby in the vicinity of their own videophones 26 in a state in which they are capable of responding.

Note that, in the case in which, at the time of sales or the like of a product or the like, a system for distributing a recording medium (e.g., an ID card, a CD-ROM, etc.) in which data specifying the product (e.g., a manufacturer name, a telephone number at the time when the communication control apparatus 1 of the manufacturer is called, a product name, a type, a manufacturing number, date and time of manufacture, etc.) is stored is adopted and, moreover, the videophone 12 on the above-described user side is given a function for reading the recording medium, connecting the videophone 12 to the above-described communication control apparatus 1 with the above-described telephone number, and sending the above-described data in response to an object of inquiry specification request from the communication control apparatus 1 side (see step S11 of FIG. 3) or automatically at predetermined timing, it becomes possible to establish a user support system which is capable of facilitating inquiry work of a user and making user support accurate and efficient.

Note that the scope of the present invention is not limited to the above-described embodiment, and various modified applications of the present invention are possible. For example, the control unit 2 of the communication control apparatus 1 in accordance with the above-described embodiment includes the nine sub-control sections, namely, the first sub-control section 201 to the ninth sub-control section 209 other than the main control section 200, and these sub-control sections back up questions and answers of nine pairs of users and responders by sharing the work. However, it is needless to mention that it is also possible to provide only the main control section 200 and the main control section 200 backs up the users and the responders, respectively, in a time division manner.

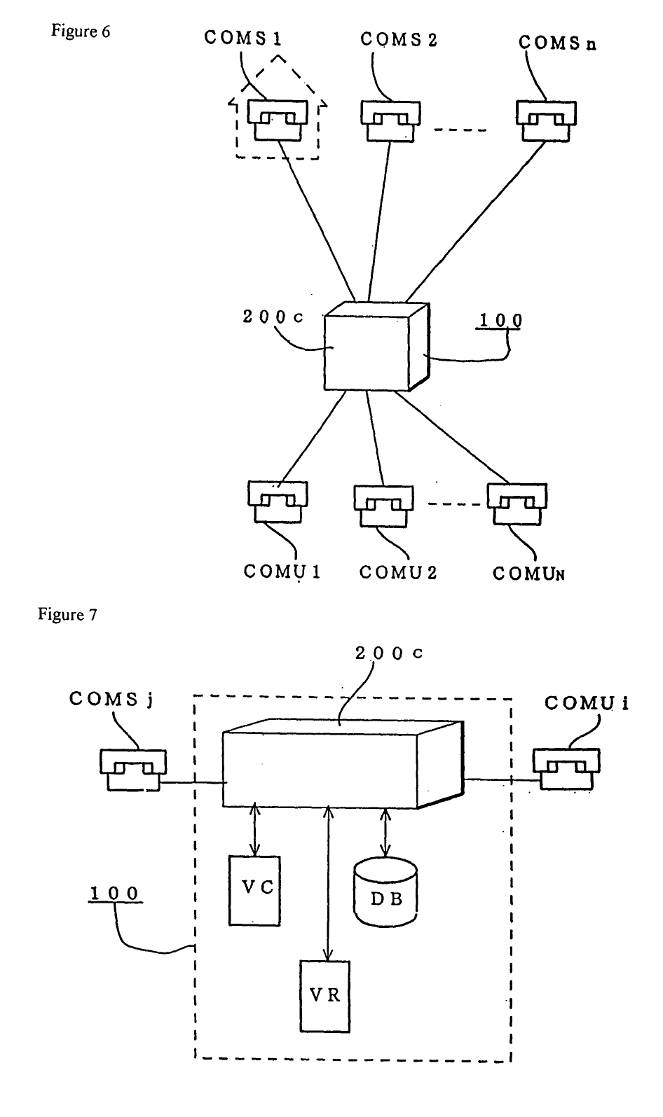

A second embodiment will be described. In FIG. 6, a communication control apparatus 100 includes a connection device 200C for connecting a plurality of customer communication apparatuses (telephone) COMU1 to COMUN and a plurality of responder communication apparatuses (telephone) COMS1 to COMSn.

Responders are responders answering inquiries of customers concerning, for example, various products, and a professional field is set for the respective responders. Consequently, a user support system is established.

The connection device selects responders in response to inquiries from customers and call communication apparatuses owned by the selected responders sequentially or at a time to make direct call between the customers and the respondents possible. The communication apparatuses COMS1 to COMSn may not exist inside a company but may be, for example, a telecommuting worker (COMS1). Consequently, respondents can be secured easily and various kinds of user support become possible.

A third embodiment will be described. FIG. 7 shows the third embodiment in which a function is added to the communication control apparatus 100. Here, in order to facilitate understanding, only a pair of customer and responder are indicated by communication apparatuses COMUi and COMSj thereof. However, as in FIG. 6, the communication control apparatus performs connection among a plurality of customers and responders.

A database DB, a speech conversion device VC, and a speech recognition device VR are connected to a connection device 200C in the communication control apparatus 100.

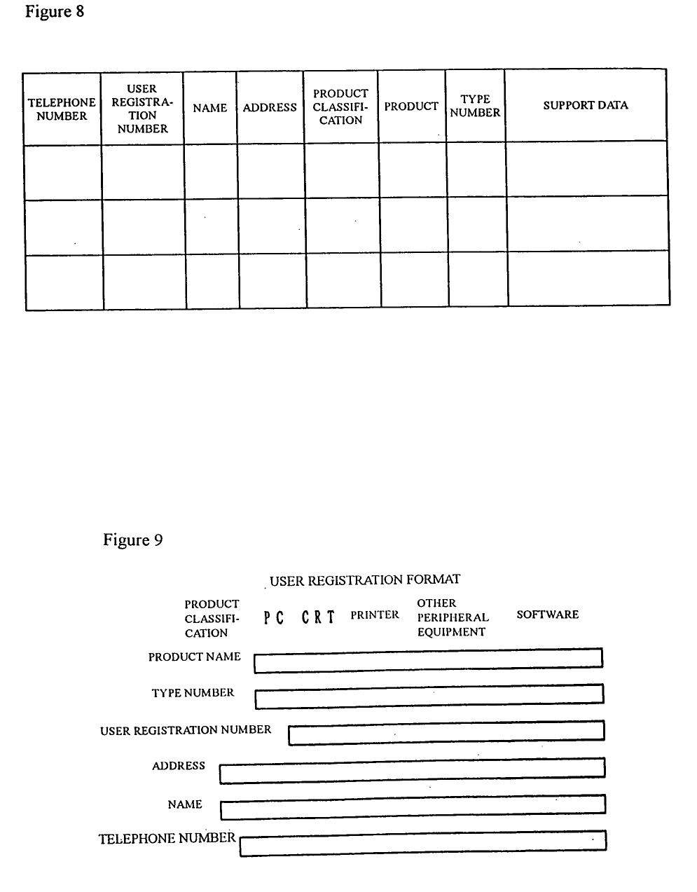

As shown in FIG. 8, the database DB stores telephone numbers of customers, user registration numbers, names, addresses, product classifications of purchased products, product names, type numbers, and support data concerning the products. Here, the support data is contents of a conversation between a customer and a responder at the time when the customer inquires about a product, and is automatically converted into character data by the speech recognition device VR and stored. Therefore, the responder never bears burden for recording the support data, and the support data can be collected surely in the communication control apparatus 100.

The speech recognition device VR converts voice data of a conversation into “hiragana characters” and does not perform conversion to Chinese characters. Consequently, high-speed processing becomes possible.

The support data is useful marketing data and, by arranging the support data as a database, powerful marketing and planning of products become possible.

The speech conversion device VC converts voices of a responder into, for example, voices of a popular personality. The respondent is required of sophisticated professional knowledge, and it is not possible to require all the responders of a customer service ability. In this regard, a customer is less likely to be given feeling of discomfort by responding to an inquiry of the customer with voices desired by the customer. A classification of products corresponds to a classification of responders, and a responder is selected based upon the product classification.

Customer data of FIG. 8 is collected according to a user registration format shown in FIG. 9. This format is distributed to a customer who has purchased a product, and the customer fills in the format.

In the user registration format, a product classification, a product name, and a type number of the purchased product are written, and the customer fills in an address, a name, and a telephone number. However, a customer who has already performed user registration through purchase of another product fills in only the user registration number (ID).

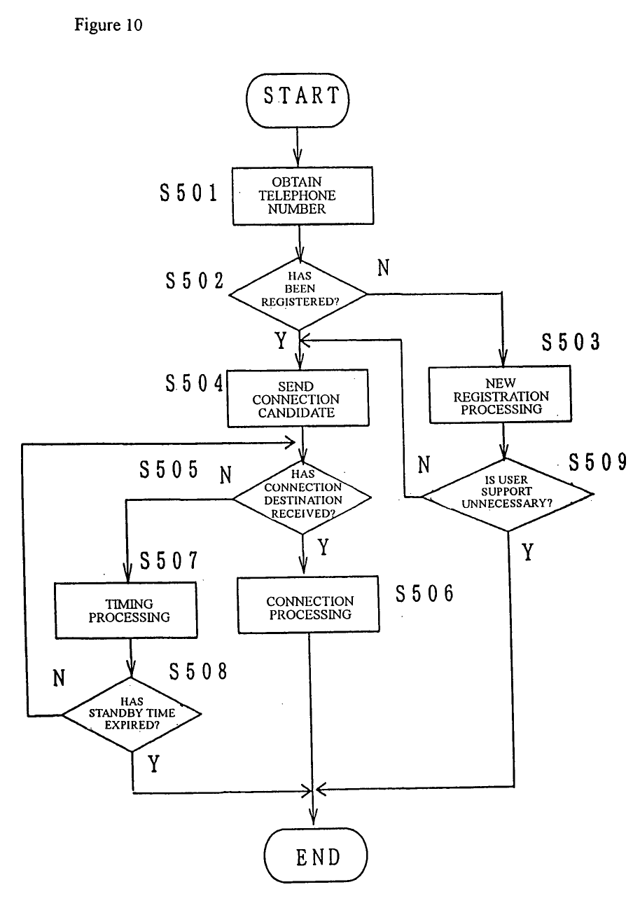

A fourth embodiment will be described. FIG. 10 is a flowchart of the fourth embodiment in which processing of a communication control apparatus is automatically performed. The processing in the second embodiment and the third embodiment can be performed automatically as in the fourth embodiment.

In FIG. 10, when any one of the customer communication apparatuses COMU1 to COMUN is connected to the communication control apparatus 100 through a public line, the communication control apparatus 100 obtains a telephone number of the communication apparatus with the “caller number notice service” (step S501). Next, the communication control apparatus 100 refers to the database DB, judges whether or not a customer of the obtained telephone number has been registered (step S502) and, when the customer has not been registered, shifts to new registration processing (step S503) When the customer has been registered, the communication control apparatus 100 sends a registered product classification and inquires the customer which connection destination the customer selects (S504). The communication control apparatus 100 judges whether or not a signal selecting a connection destination has been received in response to this (step S505) and, when it has been received, connects the customer to a corresponding responder (step S506). When a signal has not been received, the communication control apparatus 100 times waiting time (step S507) and judges the elapse of a predetermined time (step S508). When the predetermined time has elapsed, the communication control apparatus 100 ends the processing and, if the waiting time is within the predetermined time, returns to step S505.

After completion of the new registration processing (step S503), the communication control apparatus 100 inquires the customer if user support is required (step S509) and, when the customer desires the user support, shifts to step S504. When the user support is unnecessary, the communication control apparatus 100 ends the processing directly.

If customer management is performed according to a telephone number in this way, it is possible to perform connection control automatically through utilization of the caller number notice service.

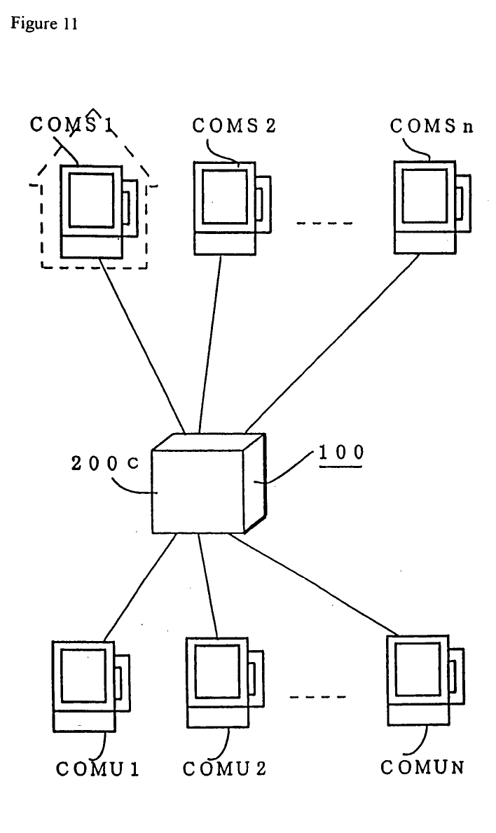

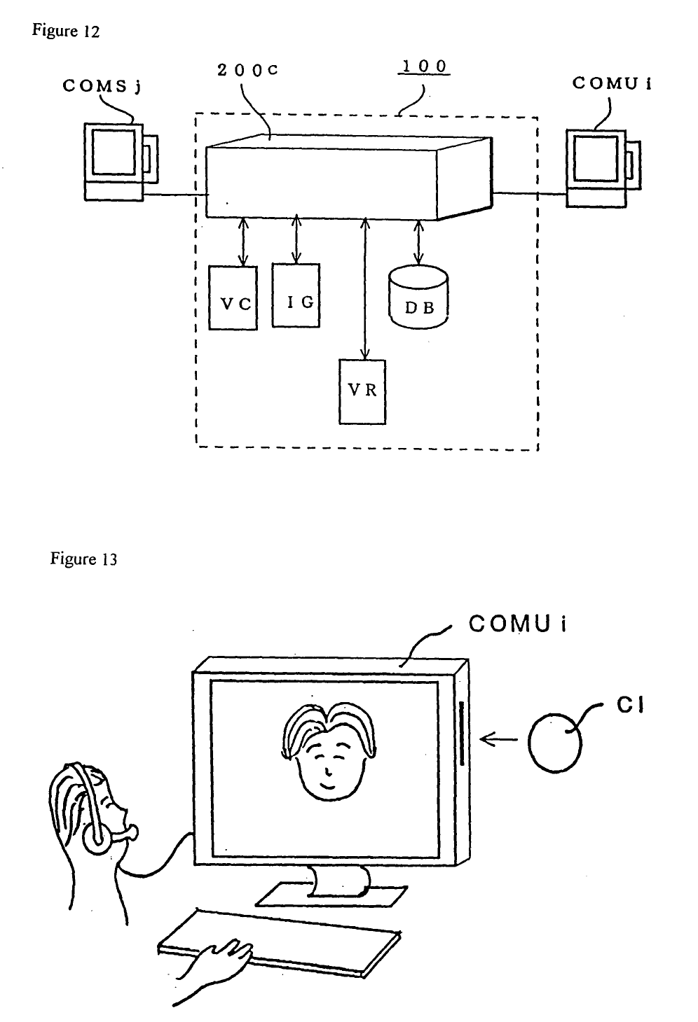

A fifth embodiment will be described. FIGS. 11 and 12 are block diagrams showing the fifth embodiment, in which a videophone is adopted as a communication apparatus in place of a telephone, and parts identical with or equivalent to those in FIGS. 6 and 8 are denoted by identical reference symbols. Note that the fifth embodiment can be performed automatically by a combination with the fourth embodiment.

According to adoption of the videophone, a customer and a responder become capable of inquiring a question and responding to it involving visual information, and more detailed information exchange is possible.

As shown in FIG. 12, in the communication control apparatus 100, an image creating device IG is connected to the connection device 200C in addition to the database DB, the speech conversion device VC, and the speech recognition device VR. The image creating device IG sends a still image or a moving image of a popular personality or the like to a communication apparatus COMUi in place of an image of a responder, and it is outputted in a communication apparatus COMUi together with converted voices. For example, voices of the responder are converted into voices of the popular personality. Consequently, burden on the responder can be reduced, and it becomes more likely that good impression is given to the customer.

A sixth embodiment will be described. In FIG. 13, the communication apparatus COMUi of the customer is a personal computer. When a product is sold, a storage medium (CD-ROM) CD for user registration is distributed to the customer. Data and communication software for making a connection to a communication control apparatus are loaded on the storage medium CD together with the registration format of FIG. 9. In the user registration, the customer inputs necessary data on the personal computer COMUi and sends the data.

After the user registration, when the customer sets the identical storage medium CD in the personal computer COMPUi and makes a connection to the communication control apparatus 100, the communication control apparatus refers to the data base and shifts to processing for user support.

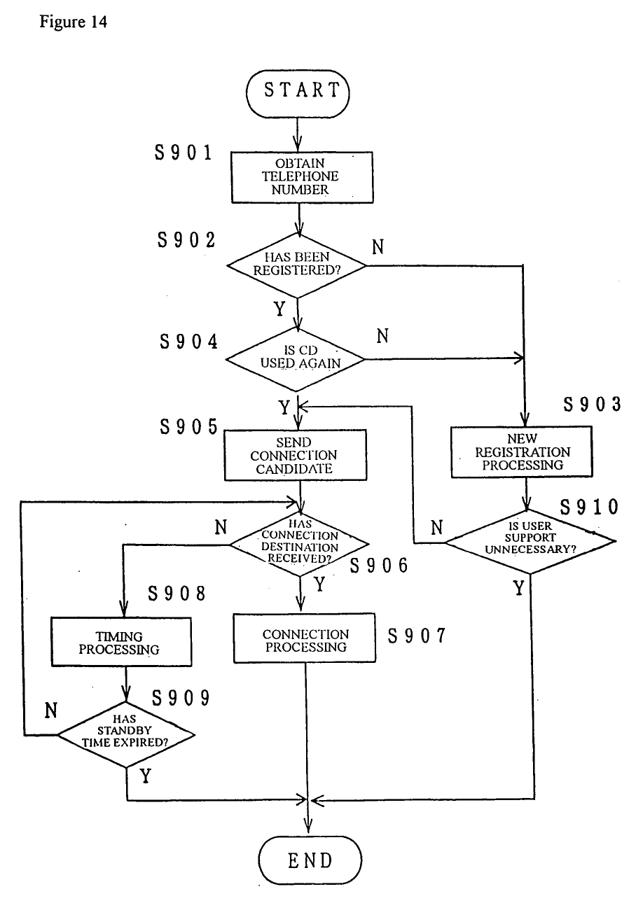

FIG. 14 is a flowchart showing processing in the communication control apparatus 100.

In FIG. 14, when any one of the customer communication apparatuses COMU1 to COMUN is connected to the communication control apparatus 100 through a public line, the communication control apparatus 100 obtains a telephone number of the communication apparatus according to the “caller number notice service” (step S901). Next, the communication control apparatus 100 refers to the database DB and judges whether or not a customer of the obtained telephone number has been registered (step S902). When the customer has not been registered, the communication control apparatus 100 shifts to new registration processing (step S903). When the customer has been registered, the communication control apparatus 100 judges whether or not the storage medium CD is being used for the first time (step S904). This judgment is possible by referring to a product type number sent from the storage medium CD on the database DB. When the storage medium CD is being used for the first time, the communication control apparatus 100 shifts to step S903. When the storage medium CD is being used again, the communication control apparatus 100 sends a registered product classification and inquires the customer which connection destination the customer selects (step S905). The communication control apparatus 100 judges whether or not a signal selecting a connection destination has been received in response to this (step S906) and, when it has been received, connects the customer to a corresponding responder (step S907). When a signal has not been received, the communication control apparatus 100 times waiting time (step S908) and judges the elapse of a predetermined time (step S909). When the predetermined time has elapsed, the communication control apparatus 100 ends the processing and, if the waiting time is within the predetermined time, returns to step S906.

After completion of the new registration processing (step S903), the communication control apparatus 100 inquires the customer if user support is required (step S910) and, when the customer desires the user support, shifts to step S905. When the user support is unnecessary, the communication control apparatus 100 ends the processing directly.

By automatically performing the connection processing for the user registration and the user support in this way, burden of processing can be reduced and, at the same time, burden on the customer can be reduced. The user registration can be facilitated through the reduction of the burden on the customer and, at the same time, marketing data can be collected more efficiently.

Note that it is also possible to make the storage medium CD writable, store data such as ID of customers therein, and send this to the communication control apparatus 100. In addition, it is also possible to adopt an ID card or the like as the storage medium.

### Industrial Applicability

As described above in detail, the response system in accordance with the present invention is extremely useful in that it can involve responders at home or the like, thereby facilitating establishment of a response service system.

1. A communication control apparatus which is used in a response system with which, when an inquiry is sent from a caller who is a customer, that is, a user or the like, to a receiver side which is a manufacturer or the like with a communication apparatus, the receiver side responds to the inquiry, characterized by comprising:
a connection destination instructing means which executes processing for calling communication apparatuses which several registered responders including at least one person who is a worker on said receiver side other than in-house workers use, respectively, using call information for calling the respective communication apparatuses and via an in-house leased line with respect to the communication apparatuses of the in-house workers or via a public communication line with respect to the communication apparatuses of workers other than the in-house workers, and instructs to connect a communication apparatus which has responded to the call first to the communication apparatus on the above-described caller side; and
a connection device which connects said communication apparatus which has responded to the call first and the communication apparatus on said caller side based upon the instruction of said connection destination instructing means.

2. A communication control apparatus which is used in a response system with which, when an inquiry is sent from a caller who is a customer, that is, a user or the like, to a receiver side which is a manufacturer or the like with a communication apparatus, the receiver side responds to the inquiry, characterized by comprising:
an object specification requesting means which, upon receiving a call from a communication apparatus on a caller side via a communication line, sends a signal for requesting to specify an object of inquiry or indicating a method of specifying an object of inquiry and requesting to specify the object of inquiry with the method of specification;
responder candidate designation means which, when an object specifying signal specifying an object of inquiry is sent from the communication apparatus of said caller side in response to said signal from said object specification requesting means, reads out each piece of call information for calling each communication apparatus which several responders who are expected to respond about the object of inquiry use, respectively, from responder classification storing means described below in accordance with an order of a responding ability described below based upon the object specifying signal;
responder classification storing means in which each piece of call information for calling each communication apparatus which several responders including at least one person who is a worker other than the in-house workers on said receiver side use, respectively, and an object of inquiry to which a responder relating to the call information is expected to respond are associated with each other and stored in a form with which an order of responding ability of the responders relating to those pieces of call information can be understood among the pieces of call information relating to the responders responding to an identical object of inquiry;
connection destination instructing means which continues processing for calling each communication apparatus relating to each piece of call information one by one in said order of a responding ability based upon said each piece of call information read out by said responder designation means until any one of the communication apparatuses responds to call, and instructs to connect the communication apparatus having responded to the call first and the communication apparatus on said caller side; and
a connection device which connects said communication apparatus having responded to the call first and the communication apparatus on said caller side based upon the instruction of said connection destination instructing means.

3. A communication control apparatus which is used in a response system with which, when an inquiry is sent from a caller who is a customer, that is, a user or the like, to a receiver side which is a manufacturer or the like with a communication apparatus, the receiver side responds to the inquiry, characterized by comprising:
object specification requesting means which, upon receiving a call from a communication apparatus on a caller side via a communication line, sends a signal for requesting specification of an object of inquiry or indicating of a method of specifying an object of inquiry and requesting specification of the object of inquiry with the method of specification;
responder candidate designation means which, when an object specifying signal specifying an object of inquiry is sent from the communication apparatus of said caller side in response to said signal from said object specification requesting means, reads out each piece of call information for calling each communication apparatus which several responders who are expected to respond about the object of inquiry use, respectively, from responder classification storing means described below based upon the object specifying signal;
responder classification storing means in which each piece of call information for calling each communication apparatus which several responders including at least one person who is a worker other than the in-house workers on said receiver side use, respectively, and an object of inquiry to which a responder relating to the call information is expected to respond are associated with each other and stored;
connection destination instructing means which calls at a time all communication apparatus relating to these pieces of call information based upon said each piece of call information read out by said responder designation means, via an in-house leased line with respect to the communication apparatuses of the in-house workers or via a public communication line with respect to the communication apparatuses of workers other than the in-house workers, and instructs connection of a communication apparatus having responded to the call first and a communication apparatus on said caller side; and
a connection device which connects said communication apparatus having responded to the call first and the communication apparatus on said caller side based upon the instruction of said connection destination instructing means.

4. The communication control apparatus according to any one of claims 1 to 3 which is used in the case in which the communication apparatus on said caller side is provided with a display section and has a function for receiving an image signal sent thereto and displaying a moving image on the display section, characterized by comprising:
an image creating device which, while said responder is responding to an inquiry, generates an image signal for displaying a moving image which looks as if a specific character performs the response, and transmits the image signal to the communication apparatus on said caller side.

5. The communication control apparatus according to any one of claims 1 to 4, characterized by comprising:
a speech conversion device which, while said responder is responding to an inquiry, takes in voices of the response sent thereto, converts the voices into voices of a specific person other than the responder and, then, transmits a voice signal relating to the voices after conversion to the communication apparatus on said caller side instead of the voice signal of the responder.

6. The communication control apparatus according to any one of claims 1 to 5, characterized by comprising:
a speech recognition device which converts a conversation performed between said caller and said responder through the above communication device into character data representing the conversation;
a storage device for database preparation; and
database preparation means which arranges and records said character data in an association with other data relating to the caller on the storage device to prepare a database.

7. A response system, characterized by comprising:
the communication apparatus on said caller side;
the communication control apparatus in accordance with any one of claims 1 to 6; and
each communication apparatus of said each responder to be selectively connected to the communication apparatus on said caller side by the communication control apparatus.

8. The response system according to claim 7, characterized by comprising a recording medium to be passed to said caller in advance, in which predetermined data relating to an object of inquiry or the like is stored, and
characterized in that the communication apparatus on said caller side reads the recording medium and connects the communication apparatus to said communication control apparatus to transmit said object specifying signal specifying the object of inquiry in response to a request from said communication control apparatus side or automatically at predetermined timing.

9. The response system according to claim 8,
characterized in that said recording medium is an ID card.

10. A communication control apparatus, characterized by comprising: a connection device which connects a communication apparatus owned by a customer and one of communication apparatuses owned by a plurality of responders, the communication control apparatus selecting responders who respond to an inquiry from the customer, calling the communication apparatuses of the selected responders at a time using call information for calling the respective communication apparatuses, and making a direct call between the customer and a responder who responded to the call first possible.

11. The communication control apparatus according to claim 10, characterized by further comprising an image creating device which creates an image of a responder, and
characterized in that the responder calls a customer while displaying the generated image on a communication apparatus of the customer.

12. The communication control apparatus according to claim 10 or 11, characterized by further comprising a speech conversion device which converts voices of a responder to generate image voices, and
characterized in that the responder calls the customer with the image voices.

13. The communication control apparatus according to any one of claims 10 to 12, characterized by further comprising a speech recognition device which converts a conversation between a customer and a responder into character data and a database which records this character data in an association with the customer.

14. A telephone response system, characterized by comprising: the communication control apparatus according to any one of claims 10 to 13; and a storage medium having information concerning an ID of a customer recorded therein, and
characterized in that a communication apparatus of the customer reads said storage medium to connect the communication apparatus to said communication control apparatus.

15. The telephone response system according to claim 14,
characterized in that the storage medium is an ID card.

16. The telephone response system according to claim 14,
characterized in that the responder is a telecommuting responder.
